(19) United States
(12) Patent Application Publication
(10) Pub. No.: US 2025/0326191 A1
(43) Pub. Date: Oct. 23, 2025

(54) METHOD FOR PRODUCING A SHAPED THERMOPLASTIC COMPOSITE, A SHAPED THERMOPLASTIC COMPOSITE AND SYSTEM FOR PRODUCING A SHAPED THERMOPLASTIC COMPOSITE

(71) Applicant: Arkema France, Colombes (FR)

(72) Inventors: Audrey LE FICHANT, Saint Avold Cedex (FR); Estelle MOUTH, Saint Avold Cedex (FR); Alexander ZOLLER, Lacq (FR); Pierre GERARD, Lacq (FR); Boris DUCHAMP, Porcelette (FR)

(73) Assignee: Arkema France, Colombes (FR)

(21) Appl. No.: 18/871,020

(22) PCT Filed: Jun. 2, 2023
(86) PCT No.: PCT/EP2023/064897

§ 371 Date: Dec. 2, 2024

(30) Foreign Application Priority Data
Jun. 3, 2022 (FR) FR2205377

(51) Int. Cl. B29C 70/52; B29C 70/54; B29K 33/00; B29L 31/06; C08F 220/14; C08J 5/24

(52) U.S. Cl. CPC B29C 70/521; B29C 70/54; C08F 220/14; C08J 5/24; B29K 2033/08; B29L 2031/06; C08J 2333/12

(57) ABSTRACT

Embodiments relate to a method for producing a shaped thermoplastic composite, the method including a pultrusion process and including:
a step of feeding, providing fibers in a direction A of a pultrusion path,
a step of wetting fibers which includes the passage of fibers through a thermoplastic composition,
a step of heating, which includes a polymerization of the thermoplastic composition having impregnated the fibers to form a heated thermoplastic composite having a first section,
a step of shaping through a shaping device having a second section, and the second section being smaller than the first section, to provide a heated thermoplastic composite having a second section, and
a step of cooling to produce a shaped thermoplastic composite.

### FIELD OF THE INVENTION

The present invention relates to the field of thermoplastic composites and more preferably the field of reinforcing elements.

This invention provides a new method for producing a shaped thermoplastic composite, a shaped thermoplastic composite and a system for producing a shaped thermoplastic composite.

### DESCRIPTION OF RELATED ART

Reinforcing elements are commonly used to reinforce structures in several fields such as automotive, transport, aeronautic, aerospace, photovoltaic, construction and building, and/or wind energy applications.

Reinforcing elements in the form of composite reinforcing elements are currently known.

Usually, a composite reinforcing element comprises a matrix (generally a polymeric matrix with thermosetting polymer) and fibers (as fibrous substrate). Such composite reinforcing elements are often produced by a pultrusion process.

Conventional pultrusion processes involve drawing a bundle of fibers through a pultrusion die allowing to wet the fibers, impregnating them by passing them through a resin bath or in an injection box, polymerizing the resin and cooling the impregnated bundle to form a composite profile at the outlet of said die.

The pultrusion process allows to obtain profiles of constant section with high mechanical properties. The profile is completely formed when it leaves the pultrusion die. In the case of thermosetting resins, the profile is moreover not modifiable after leaving the die.

This technique requires providing complete tooling for each section of profile that one wishes to manufacture, from the impregnation zone to the outlet of the die.

In addition, thermosetting polymers have other drawbacks such as long cycle times, high energy consumption, low recyclability of the materials used, toxicity of certain components and the emission of volatile organic compounds. An additional disadvantage of thermosetting materials is the volume shrinkage after curing which affects dimensional stability and surface appearance after molding and requires specific treatment.

It is also known to manufacture reinforcing element with resin including thermoplastic polymer. Advantageously, the reinforcing element with thermoplastic polymer may be successively heated and cooled to change or modify the geometry of the thermoplastic polymer.

However, successive heatings reduce the thermal stability and unfavorably alter some characteristics of the reinforcing element such as bending resistance, flexural strength, and may result in retention and delamination.

Pultrusion processes with thermoplastic polymer may comprise melting the polymer, impregnating the fibers and calibrating by cooling, without polymerization reaction. However, the rate of impregnation of the fibers is low and d inhomogeneous. Indeed, because of the high viscosity of thermoplastic resins, a sufficient and homogeneous impregnation of the fibers is currently difficult to reach. Indeed, on the one hand, the viscosity of the resin generates very high-pressure levels which causes the breaking of the fibers (likely to cause mechanical deficiencies, in particular delamination of the fibers and weaken the final composite material) and on the other hand, the poor homogeneity (areas rich in resin and areas rich in fibers) leads to the creation of flow paths for the resin which weakens the composite. These problems are accentuated with the use of resins exhibiting high melting temperatures.

To solve this problem, the international patent application WO2017219143 proposes as a solution a method for pultruding a beam comprising a first die having a tapered channel portion and heated, to reach the desired viscosity, a vacuum cavity, to remove air and a second die having a tapering channel portion also heated, to increase the impregnation of fibers. However, heating, impregnation and shaping are performed at the same time. According to this method many volatile compounds are produced, and thus increases the porosity of the composite, volatile compounds remaining trapped in the composite. In addition, this method requires a feeding with preform including polymer and fibers without polymerization and therefore the same drawbacks as above are reproduced (mechanical deficiencies, delamination of fibers and weakening of the final composite material).

Finally, other techniques have been developed and in particular reactive pultrusion. This technology uses reactive thermoplastic monomers with very low viscosity which makes it possible to impregnate a large quantity of fibers. In this case, the profile generally comes out according to the final shape of the pultrusion die, incorporates an impregnation zone followed by the polymerization zone having the shape of the desired profile so that the composite leaves the die in its final form, generally in the solid state. The polymerization zone therefore also acts as a calibration zone.

The document FR3053915 discloses a method and apparatus for obtaining a part made of thermoplastic composite.

The document US2013/0134621 discloses a stabilized dry preform and method for forming such a preform, said preform contains fibers and thermoplastic resin.

Although these techniques attempt to calibrate composites (thermosets or thermoplastics), composites generally exhibit shrinkage. The polymerization reaction also leads to significant shrinkage. The shrinkage leads to a loss of pressure in the pultrusion die during the process. This loss of pressure causes relatively high porosity leading to a decreased mechanical property, more residual monomer, higher water uptake, loss of electrical conductivity and chemical resistance. Indeed, more gas and air are present in the composite decreasing its qualities.

Moreover, some polymers have high water absorption in humid conditions, which can lead to dimensional changes, internal stresses, delamination, and significant changes in the properties of the matrix.

Hence, there is a need for solutions capable of generating a shaped thermoplastic composite with a reduced porosity.

### SUMMARY OF THE INVENTION

The following sets forth a simplified summary of selected aspects, embodiments and examples of the present invention for the purpose of providing a basic understanding of the invention. However, this summary does not constitute an extensive overview of all the aspects, embodiments and examples of the invention. The sole purpose of the summary is to present selected aspects, embodiments and examples of the invention in a concise form as an introduction to the more detailed description of the aspects, embodiments and examples of the invention that follow the summary.

The invention aims to overcome the disadvantages of the prior art. In particular, the invention proposes a method for producing a shaped thermoplastic composite, said method comprising a pultrusion process and comprising:
a step of feeding, by fiber feeder device, said step of feeding provides fibers in a direction of a pultrusion path;
a step of wetting fibers, by an impregnation device, which comprises the passage of fibers through a thermoplastic composition, said thermoplastic composition being a thermoplastic resin or a thermoplastic resin precursor and comprising at least 50% in weight of monomers;
a step of heating, by a heating device, which includes a polymerization of the thermoplastic composition having impregnated the fibers to form a heated thermoplastic composite having a first section;
a step of shaping the heated thermoplastic composite, by pulling the heated thermoplastic composite through a shaping device, the shaping device having a second section, and the second section being smaller than the first section, to provide a heated thermoplastic composite having a second section;
a step of cooling, by a cooling device, at a cooling temperature below to a glass transition temperature of the heated thermoplastic composite having the second section to produce a shaped thermoplastic composite.

The advantage of this method is that it results in a shaped thermoplastic composite with a decrease porosity compared to those obtained with the current conventional processes. Indeed, the developed method makes it possible to apply pressure to the thermoplastic composite during production, which allows to reduce the porosity. Advantageously, this pressure is applied to the heated thermoplastic composite, which facilitates the application of pressure. Consequently, the shaped thermoplastic composite has reduced porosity, which improve its mechanical and chemical properties.

In addition, thanks to the method, both chemical and thermal shrinkage are considered, which further reduces porosity.

Moreover, the method improves the surface qualities such as a smoother and less rough surface which facilitates further treatments such as coating.

The method according to the invention therefore improves the electrical conductivity, the chemical and/or mechanical resistance of shaped thermoplastic composites while allowing reducing water uptake, alkaline attack, dimensional changes, and changes in the matrix.

Advantageously, thanks to the method the production of volatile compounds is reduced, and they are not trapped in the shaped thermoplastic composite.

According to other optional features of the method according to the invention, it can optionally include one or more of the following characteristics alone or in combination:
the pultrusion process is a reactive pultrusion process, improving mechanical and/or chemical properties,
the feeding step and the wetting step are carried out so that the shaped thermoplastic composite comprises at least 60% in volume of fibers, thereby improving mechanical and/or chemical properties of the shaped thermoplastic composite,
the step of cooling is at the same time as the step of shaping, which saves time and takes into account the thermal shrinkage for example,
the method comprises a step of evacuation before the step of shaping, which allows to reduce porosity and reduces the presence of air and volatile compounds in the heated thermoplastic composite which further reduces porosity.

According to another aspect, the present invention also relates to a shaped thermoplastic composite obtainable, preferably obtained, from the method according to the invention. A shaped thermoplastic composite according to the invention has a reduced porosity which allows better mechanical and/or chemical properties, better water uptake (here better water uptake means that the uptake water is lower) and better electrical conductivity. Advantageously, the shaped thermoplastic composite according to the invention may comprise less than or equal to 10% porosity based on the total volume of the shaped thermoplastic composite.

According to another aspect of the present invention, it is provided a use of a shaped thermoplastic composite according to the invention in automotive, transport, nautical, railroad, sport, aeronautic, aerospace, photovoltaic, computing, construction and building, telecommunication wind energy applications. Indeed, having shaped thermoplastic composite with reduce porosity is of a particular interest in these fields.

According to another aspect, the present invention concerns a shaping device adapted to reduce a first section of a heated thermoplastic composite to a second section to form a shaped thermoplastic composite having a second section, said second section being smaller than the first section and the shaped thermoplastic composite comprising at least 60% in volume of fibers. A shaping device according to the invention, allows to reduce porosity of the thermoplastic composite and consequently to obtain better qualities. Advantageously, the shaping device is also adaptable and may be implemented in any pultrusion or reactive pultrusion system for thermoplastics. The shaping device according to the invention may comprise at least one inlet and at least one outlet, the outlet being smaller than the inlet, thereby applying pressure.

According to another aspect the present invention relates to a system for producing a shaped thermoplastic composite, comprising:
a fiber feeder device, configured to provide fibers in a direction of a pultrusion path,
an impregnation device, configured to wet fibers through a thermoplastic composition, said thermoplastic composition being a thermoplastic resin or a thermoplastic resin precursor and comprising at least 50% in weight of monomers,
a heating device configured to cause a polymerization of the thermoplastic composition having impregnated the fibers to form a heated thermoplastic composite having a first section,
a shaping device configured to shape the heated thermoplastic composite according to a second section, the shaping device having a second section, and the second section being smaller than the first section, to provide a heated thermoplastic composite having a second section, the shaping device being facing to the previous device,
a cooling device, configured at a cooling temperature below to a glass transition temperature of the heated thermoplastic composite having the second section to produce a shaped thermoplastic composite.

The system according to the invention allows to produce a shaped thermoplastic composite with a reduced porosity.

According to other optional features of the system according to the invention, it can optionally include one or more of the following characteristics alone or in combination:
it comprises an empty space, a vacuum or an air space,
the empty space, the vacuum, or the air space is arranged between, the heating device and the shaping device,
the shaping device comprises at least one inlet and at least one outlet, the outlet facing the cooling device.

### BRIEF DESCRIPTION OF DRAWINGS

The foregoing and other objects, features and advantages of the present invention will become more apparent from the following detailed description when taken conjunction with in the accompanying drawings in which:

FIG. 1 represents a flowchart of a method according to an embodiment of the invention.

FIG. 2 represents a schematic view of a system according to an embodiment of the invention.

FIG. 3 represents a graded field microscopy images of a shaped thermoplastic composite.

Several aspects of the present invention are disclosed with reference to flow diagrams and/or block diagrams of methods, and devices according to embodiments of the invention.

On the figures, the flow diagrams and/or block diagrams show the architecture, the functionality and possible implementation of devices or systems or methods, according to several embodiments of the invention.

For this purpose, each box in the flow diagrams or block diagrams may represent a system, a device, a module which comprises several executable instructions for implementing the specified logical function(s).

In some implementations, the functions associated with the box may appear in a different order than indicated in the drawings.

For example, two boxes successively shown, may be executed substantially simultaneously, or boxes may sometimes be executed in the reverse order, depending on the functionality involved.

Each box of flow diagrams or block diagrams and combinations of boxes in flow diagrams or block diagrams may be implemented by special systems that perform the specified functions or actions or perform combinations of special and equipment computer instructions.

### DETAILED DESCRIPTION

A description of example embodiments of the invention follows.

By “polymer” is meant either a copolymer or a homopolymer or a block copolymer. The term “copolymer” means a polymer grouping different and together several monomer units the term “homopolymer” means a polymer grouping identical monomer units. By “block copolymer” is meant a polymer comprising one or more uninterrupted blocks of each of the distinct polymer species, the polymer blocks being chemically different from each other and being linked together by a covalent bond. These polymer blocks are also called polymer blocks.

The expression “polymer composite”, within the meaning of the invention, denotes a multicomponent material comprising at least two immiscible components in which at least one component is a polymer, and the other component may for example be a fibrous reinforcement.

By “fibrous reinforcement” or “fibrous substrate” or “fibers” is meant, within the meaning of the invention, several fibers, unidirectional fibers or of braids, or a continuous filament mat, fabrics, felts, or nonwovens which may be under the form of bands, webs, braids, wicks or pieces.

The term “matrix” can refer to a material serving as a binder and capable of transferring forces to the fibrous reinforcement. The “polymer matrix” includes polymers but can also include other compounds or materials. Thus, the “(meth)acrylic polymer matrix” refers to all types of compounds, polymers, oligomers, copolymers or block copolymers, acrylics and methacrylics. However, it would not be departing from the scope of the invention if the (meth)acrylic polymer matrix comprises up to 10% by weight, preferably less than 5% by weight of other non-acrylic monomers, chosen for example from the group: butadiene, isoprene, styrene, substituted styrene such as α-methylstyrene or tert-butylstyrene, cyclosiloxanes, vinylnaphthalenes and vinyl pyridines.

The term “initiator”, or “precursor” within the meaning of the invention, can refer to a compound which can start/initiate/continue the polymerization of a monomer or of monomers. The term “initiator” is preferred to a compound which can start/initiate the polymerization of a monomer or of monomers.

The term “polymerization” within the meaning of the invention can refer to the process of converting a monomer or a mixture of monomers into a polymer.

The term “monomer”, within the meaning of the invention, can refer to a molecule which can undergo polymerization.

For the purposes of the invention, the term “thermoplastic polymer” can refer to a polymer which is generally solid at room temperature, which may be crystalline, semi-crystalline or amorphous, and which softens during an increase in temperature, in particular after passing its glass transition temperature (Tg) and flowing at a higher temperature and/or being able to observe a clear melting at the passage of its so-called melting temperature (Tf) (when it is semi-crystalline), and which becomes solid again when the temperature drops below its melting point and below its glass transition temperature. This also applies for thermoplastic polymers slightly crosslinked by the presence of multifunctional monomers or oligomers in the formulation of the “syrup” (meth)acrylate, in percentage by mass preferably less than 10%, preferably less than 5% and so preferred less than 2% and may be at least 0.5%, which can be thermoformed when heated above the softening temperature.

The term “thermoplastic composition” can refer to a thermoplastic syrup or thermoplastic resin or a thermoplastic resin precursor but also mixtures of a thermoplastic resin or a thermoplastic resin precursor respectively with monomers. The term “thermoplastic resin precursor” refers to a prepolymer, comprising already several polymerized monomers as monomer units in the prepolymer is capable of further prepolymer chain, said polymerization in order to achieve a higher molecular mass once fully polymerized or in other words can continue to polymerize.

The term “thermosetting polymer” can refer to a plastic material which irreversibly transforms by polymerization.

The term “(meth)acrylic monomer” can refer to any type of acrylic and methacrylic monomer.

The term “(meth)acrylic polymer” can refer to a polymer essentially comprising (meth)acrylic monomers which represent at least 50% by weight or more of the (meth)acrylic polymer.

The term “PMMA”, within the meaning of the invention, can refer to homopolymers and copolymers of methyl methacrylate (MMA), the weight ratio of MMA in the PMMA preferably being at least 70% by weight for the MMA copolymer.

The expression “reinforcing element” as used can refer to an element used within/with a structure in order to strengthen it, support it, solidify it, consolidate it, improve its mechanical properties (reinforcement, tension, stretching, etc.) its thermal, electrical and/or chemical properties.

The term “rebar” can refer to a reinforcing bar that is used as a tension device in reinforced concrete and reinforced masonry structures to strengthen and aid the concrete under tension. Rebar significantly increases the tensile strength of concrete or the structure.

The abbreviation “phr” can refer to parts by weight per hundred parts of composition. For example, 1 phr of initiator in the composition means that 1 kg of initiator is added to 100 kg of composition.

The abbreviation “ppm” can refer to parts by weight per million parts of composition. For example, 1000 ppm of a compound in the composition means that 0.1 kg of the compound is present in 100 kg of the composition.

In the following description, “shape” can refer to a form preferably a geometric form such as circular, tubular, conical, pyramidal, parallelepipedal, rectangular, square, trapezoid, with at least one section.

The term “section” may be defined by a dimension of thickness, diameter, width, slope or by an area such as area or perimeter or even a volume. For example, a section may correspond to the form cut out along a transverse plane.

The term “about” as used herein can allow for a degree of variability in a value or range, for example, within 10%, within 5%, or within 1% of a stated value or of a stated limit of a range.

As mentioned, the current thermoplastic composite production does not take into account either porosity or the various shrinkages occurring during polymerization or heating and cooling operations. This the leads to production of composite thermoplastic with a high porosity which consequently leads to reduced qualities in terms of mechanical and chemical resistance, electrical conductivity and sensitivity to water. There is a need for a new method capable of generating a shaped thermoplastic composite with a reduced porosity and therefore with better qualities.

According to a first aspect, the invention relates to a method for producing a shaped thermoplastic composite, said method comprising a pultrusion process. Preferably, the pultrusion process is a reactive pultrusion process.

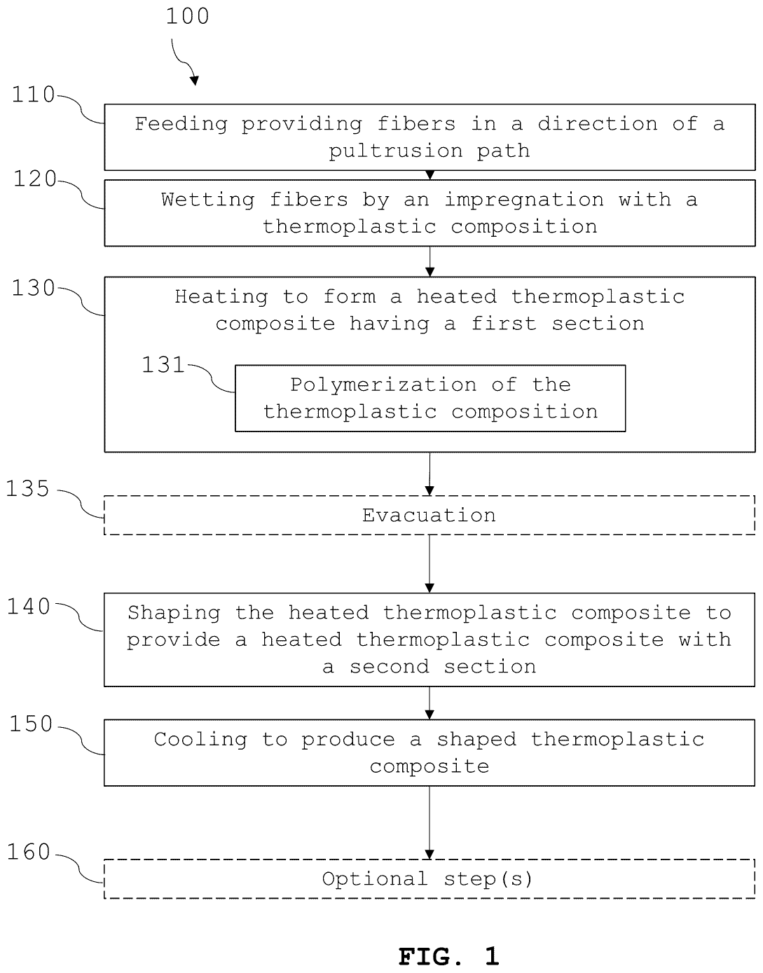

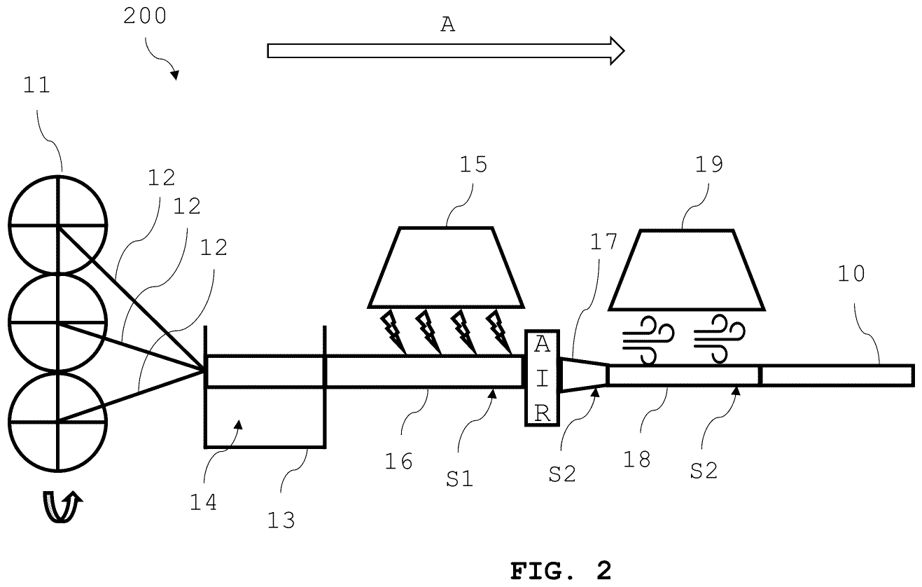

In particular, as illustrated in FIGS. 1 and 2, a method 100 for producing a shaped thermoplastic composite 10 according to the invention will comprise the following steps: a step of feeding 110; a step of wetting 120; a step of heating 130; a step of shaping 140; a step of cooling 150.

As shown in FIG. 1, the method according to the invention comprises a step of feeding 110. The step is preferably implemented by a fiber feeder device 11 illustrated for example in FIG. 2.

The step of feeding 110 fibers 12 allows to provide fibers 12 in a direction A of a pultrusion path. The fibers 12 may be made of several fibers, unidirectional rovings or continuous filament mat, fabrics, felts or nonwovens that may be in the form of strips, laps, braids, locks or pieces. The fibrous material of the composite may have various forms and dimensions, either one-dimensional, two-dimensional or three-dimensional.

The one-dimensional form corresponds to linear long fibers. The fibers may be discontinuous or continuous. The fibers may be arranged randomly or parallel to each other, in the form of a continuous filament. A fiber is defined by its aspect ratio, which is the ratio between the length and diameter of the fiber. Preferably, the fibers used in the present invention are long fibers or continuous fibers. The fibers may have an aspect ratio of at least 1000, preferably at least 1500, more preferably at least 2000, advantageously at least 3000 and more advantageously at least 5000, even more advantageously at least 6000, more advantageously still at least 7500 and most advantageously at least 10 000.

The two-dimensional form corresponds to nonwoven or woven fibrous mats or reinforcements or bundles of fibers, which may also be braided. Even if the two-dimensional form has a certain thickness and consequently in principle a third dimension, it is considered as two-dimensional according to the present invention.

The three-dimensional form corresponds, for example, to nonwoven fibrous mats or reinforcements or stacked or folded bundles of fibers or mixtures thereof, an assembly of the two-dimensional form in the third dimension.

The origins of the fibrous material may be natural or synthetic. As natural material one can mention plant fibers, wood fibers, animal fibers or mineral fibers.

Natural fibers are, for example, sisal, jute, hemp, flax, cotton, coconut fibers, and banana fibers. Animal fibers are, for example, wool or hair.

As synthetic material, mention may be made of polymeric fibers chosen from fibers of thermosetting polymers, of thermoplastic polymers, of polyamide (aliphatic or aromatic), polyester, polyvinyl alcohol, polyolefins, polyurethanes, polyvinyl chloride, polyethylene, unsaturated polyesters, epoxy resins and vinyl esters, and/or carbon fibers or mixtures thereof.

The mineral fibers may also be chosen from glass fibers, especially of E, R or S2 type, boron fibers, basalt fibers or silica fibers.

The fibrous substrate of the present invention may be chosen from plant fibers, wood fibers, animal fibers, mineral fibers, synthetic polymeric fibers, glass fibers and carbon fibers, and mixtures thereof.

Preferably, the fibrous substrate is chosen from mineral fibers. More preferably the fibrous substrate is chosen from glass fibers or carbon fibers.

The fibers of the fibrous substrate can have a diameter between 0.005 μm and 100 μm, preferably between 1 μm and 50 μm, more preferably between 5 μm and 30 μm and advantageously between 10 μm and 25 μm.

Preferably, the fibers of the fibrous substrate of the present invention are chosen from continuous fibers (meaning that the aspect ratio does not necessarily apply as for long fibers) for the one-dimensional form, or for long or continuous fibers for the two-dimensional or three-dimensional form of the fibrous substrate.

The method according to the invention may comprise a step of wetting 120 fibers 12. The step is preferably implemented by an impregnation device 13. The step of wetting allows fibers 12 to be impregnated with the thermoplastic composition 14 in other word the penetration of the thermoplastic composition into the fibers.

The step of wetting fibers may comprise the passage of fibers through a thermoplastic composition 14. For example, the fibers are guided through bath or an injection chamber comprising the thermoplastic composition. The thermoplastic composition 14 may be a thermoplastic resin or a thermoplastic resin precursor and comprising at least 50% in weight of monomers of the thermoplastic composite. In the case where the thermoplastic composition 14 comprises a thermoplastic resin and at least 50% in weight of monomers, the monomer part is polymerized during the heating step 130 in order to form together the thermoplastic resin of the thermoplastic composition 14 which has impregnated fibers 12 the matrix of the thermoplastic composite. In the case where the thermoplastic composition 14 comprises a thermoplastic resin precursor and at least 50% in weight of monomers, the monomer part is polymerized and the molecular weight of thermoplastic resin precursor increases due to continued polymerization during the heating step 130 in order to form together the matrix of the thermoplastic composite. The thermoplastic composition 14 may comprise a polymer and a monomer.

Preferably the monomer of the thermoplastic composite is selected from alkyl acrylic monomers, alkyl methacrylic monomers, hydroxyalkyl acrylic monomers and hydroxyalkyl methacrylic monomers, and mixtures thereof.

Preferably the polymer of the thermoplastic composite is selected from all types of compounds, polymers, oligomers, copolymers or block copolymers, acrylics and methacrylics. However, it would not be departing from the scope of the invention if the (meth)acrylic polymer matrix comprises up to 10% by weight, preferably less than 5% by weight of other non-acrylic monomers, chosen for example from the group: butadiene, isoprene, styrene, substituted styrene such as-methylstyrene or tert-butylstyrene, cyclosiloxanes, vinylnaphthalenes and vinyl pyridines.

The thermoplastic composition 14 according to the invention may comprise between 10 wt % and 50 wt % of a (meth)acrylic polymer (PI) and between 50 wt % and 90 wt % of a (meth)acrylic monomer (Ml). Preferably the thermoplastic composition comprises between 10 wt % and 40 wt % of a (meth)acrylic polymer (PI) and between 60 wt % and 90 wt % of a (meth)acrylic monomer (Ml); and more preferably between 10 wt % and 30 wt % of a (meth)acrylic polymer (PI) and between 70 wt % and 90 wt % of a (meth)acrylic monomer (Ml).

The dynamic viscosity of the thermoplastic composition 14 is in a range from 10 mPa*s to 10000 mPa*s, preferably from 20 mPa*s to 7000 mPa*s and advantageously from 20 mPa*s to 5000 mPa*s and more advantageously from 20 mPa*s to 2000 mPa*s and even more advantageously between 20 mPa*s and 1000 mPa*s. The viscosity of the thermoplastic composition can be easily measured with a Rheometer or viscosimeter. The dynamic viscosity is measured at 25° C. If the thermoplastic composition has a Newtonian behavior, meaning no shear thinning, the dynamic viscosity is independent of the shearing in a rheometer or the speed of the mobile in a viscometer. If the thermoplastic composition has a non-Newtonian behavior, meaning shear thinning, the dynamic viscosity is measured at a shear rate of 1 s⁻¹ at 25° C.

As regards thermoplastic composition 14 of the invention it comprises a (meth)acrylic monomer (Ml) and a (meth)acrylic polymer (PI). Once polymerized the monomer (Ml) is transformed to a (meth)acrylic polymer (P2) comprising the monomeric units of (meth)acrylic monomer (Ml) and other possible monomers. As the thermoplastic composition 14 of the invention, comprises essentially a (meth)acrylic monomer (Ml) and a (meth)acrylic polymer (PI), it is also referred to as (meth)acrylic composition MCI. As the thermoplastic composition 14 of the invention, comprising essentially a (meth)acrylic monomer (Ml) and a (meth)acrylic polymer (PI) is liquid it is also referred to as (meth)acrylic syrup.

Preferably dynamic viscosity of the (meth)acrylic composition MCI is also in a range from 10 mPa*s to 10000 mPa*s, preferably from 20 mPa*s to 7000 mPa*s and advantageously from 20 mPa*s to 5000 mPa*s and more advantageously from 20 mPa*s to 2000 mPa*s and even more advantageously between 20 mPa*s and 1000 mPa*s.

As regards the (meth)acrylic polymer (PI), mention may be made of polyalkyl methacrylates or polyalkyl acrylates. According to a preferred embodiment, the (meth)acrylic polymer (PI) is polymethyl methacrylate (PMMA).

According to one embodiment, the methyl methacrylate (MMA) homo- or copolymer comprises at least 70%, preferably at least 80%, advantageously at least 90% and more advantageously at least 95% by weight of methyl methacrylate.

According to another embodiment, the PMMA is a mixture of at least one homopolymer and at least one copolymer of MMA, or a mixture of at least two homopolymers or two copolymers of MMA with a different average molecular weight, or a mixture of at least two copolymers of MMA with a different monomer composition.

The copolymer of methyl methacrylate (MMA) comprises from 70% to 99.9% by weight of methyl methacrylate and from 0.1% to 30% by weight of at least one monomer containing at least one ethylenic unsaturation that can copolymerize with methyl methacrylate.

These monomers are well known, and mention may be made especially of acrylic and methacrylic and acids alkyl (meth)acrylates in which the alkyl group contains from 1 to 12 carbon atoms. As examples, mention may be made of methyl acrylate and ethyl-, butyl- or 2-ethylhexyl (meth)acrylate. Preferably, the comonomer is an alkyl acrylate in which the alkyl group contains from 1 to 4 carbon atoms.

According to a first preferred embodiment, the copolymer of methyl methacrylate (MMA) comprises from 80% to 99.9%, advantageously from 90% to 99.9% and more advantageously from 90% to 99.9% by weight of methyl methacrylate and from 0.1% to 20%, advantageously from 0.1% to 10% and more advantageously from 0.1% to 10% by weight of at least one monomer containing at least one ethylenic unsaturation that can copolymerize with methyl methacrylate. Preferably, the comonomer is chosen from methyl acrylate and ethyl acrylate, and mixtures thereof.

The weight-average molecular mass of the (meth)acrylic polymer (PI) should be high, which means greater than 50 000 g/mol and preferably greater than 100 000 g/mol.

The weight-average molecular mass can be measured by size exclusion chromatography (SEC).

The (meth)acrylic polymer (PI) is fully soluble in the (meth)acrylic monomer (Ml) or in the mixture of (meth)acrylic monomers. It enables the viscosity of the (meth)acrylic monomer (Ml) or the mixture of (meth)acrylic monomers to be increased. The solution obtained is a liquid composition generally called a “syrup” or “prepolymer”. The dynamic viscosity value of the liquid (meth)acrylic syrup is between 10 mPa·s and 10 000 mPa·s. The viscosity of the syrup can be readily measured with a rheometer or a viscometer. The dynamic viscosity is measured at 25° C.

Advantageously, the liquid (meth)acrylic composition or syrup contains no additional voluntarily added solvent.

As regards the (meth)acrylic monomer (Ml), the monomer is chosen from alkyl acrylic monomers, alkyl methacrylic monomers, hydroxyalkyl acrylic monomers and hydroxyalkyl methacrylic monomers, and mixtures thereof.

Preferably, the (meth)acrylic monomer (Ml) is chosen from hydroxyalkyl acrylic monomers, hydroxyalkyl methacrylic monomers, alkyl acrylic monomers, alkyl methacrylic monomers and mixtures thereof, the alkyl group containing from 1 to 22 linear, branched or cyclic carbons; the alkyl group preferably containing from 1 to 12 linear, branched or cyclic carbons.

More preferably, the (meth)acrylic monomer (Ml) is chosen from alkyl acrylic monomers or alkyl methacrylic monomers and mixtures thereof, the alkyl group containing from 1 to 22 linear, branched or cyclic carbons; the alkyl group preferably containing from 1 to 12 linear, branched or cyclic carbons.

Advantageously, the (meth)acrylic monomer (Ml) is chosen from methyl methacrylate, ethyl methacrylate, methyl acrylate, ethyl acrylate, methacrylic acid, acrylic acid, n-butyl acrylate, isobutyl acrylate, n-butyl methacrylate, isobutyl methacrylate, cyclohexyl acrylate, cyclohexyl methacrylate, isobornyl acrylate, isobornyl methacrylate, hydroxyethyl acrylate and hydroxyethyl methacrylate, and mixtures thereof.

More advantageously, the (meth)acrylic monomer (Ml) is chosen from methyl methacrylate, ethyl methacrylate, methyl acrylate, ethyl acrylate, methacrylic acid, acrylic acid, n-butyl acrylate, isobutyl acrylate, n-butyl methacrylate, isobutyl methacrylate, cyclohexyl acrylate, cyclohexyl methacrylate, isobornyl acrylate, isobornyl methacrylate, and mixtures thereof.

According to a preferred embodiment, at least 50% by weight and preferably at least 60% by weight of the (meth)acrylic monomer (Ml) is methyl methacrylate.

According to a first more preferred embodiment, at least 50% by weight, preferably at least 60% by weight, more preferably at least 70% by weight, advantageously at least 80% by weight and even more advantageously 90% by weight of the (meth)acrylic monomer (Ml) is a mixture of methyl methacrylate with optionally at least one other monomer.

The thermoplastic composition 14 of the invention or (meth)acrylic composition MCI could comprise additionally a (meth)acrylic monomer (M2). As regards the (meth)acrylic monomer (M2), the monomer is multifunctional. Preferably the (meth)acrylic monomer (M2) is chosen from a compound comprising at least two (meth)acrylic functions. The (meth)acrylic monomer (M2) can also be chosen from a mixture of at least two compounds (M2a) and (M2b) each respectively comprising at least two (meth)acrylic functions.

The (meth)acrylic monomer (M2) can be chosen from 1,3-butylene glycol dimethacrylate; 1,4-butanediol dimethacrylate; 1,6 hexanediol diacrylate; 1,6 hexanediol dimethacrylate; diethylene glycol dimethacrylate; dipropylene glycol diacrylate; ethoxylated (10) bisphenol a diacrylate; ethoxylated (2) bisphenol a dimethacrylate; ethoxylated (3) bisphenol a diacrylate; ethoxylated (3) bisphenol a dimethacrylate; ethoxylated (4) bisphenol a diacrylate; ethoxylated (4) bisphenol a dimethacrylate; ethoxylated bisphenol a dimethacrylate; ethoxylated (10) bisphenol dimethacrylate; ethylene glycol dimethacrylate; polyethylene glycol (200) diacrylate; polyethylene glycol (400) diacrylate; polyethylene glycol (400) dimethacrylate; polyethylene glycol (400) dimethacrylate; polyethylene glycol (600) diacrylate; polyethylene glycol (600) dimethacrylate; polyethylene glycol 400 diacrylate; propoxylated (2) neopentyl glycol diacrylate; tetraethylene glycol diacrylate; tetraethylene tricyclodecane dimethanol diacrylate; glycol dimethacrylate; tricyclodecanedimethanol dimethacrylate; triethylene glycol diacrylate; triethylene glycol dimethacrylate; tripropylene glycol diacrylate; ethoxylated (15) trimethylolpropane triacrylate; ethoxylated (3) trimethylolpropane triacrylate; ethoxylated (6) trimethylolpropane triacrylate; ethoxylated (9) trimethylolpropane triacrylate; ethoxylated 5 pentaerythritol triacrylate; ethoxylated (20) trimethylolpropane triacrylate; propoxylated (3) glyceryl triacrylate; trimethylolpropane triacrylate; propoxylated (5.5) glyceryl triacrylate; pentaerythritol triacrylate; propoxylated (3) glyceryl triacrylate; propoxylated (3) trimethylolpropane triacrylate; trimethylolpropane triacrylate; trimethylolpropane trimethacrylate; tris (2-hydroxy ethyl) isocyanurate triacrylate; di-trimethylolpropane tetraacrylate; dipentaerythritol pentaacrylate; ethoxylated (4) pentaerythritol tetraacrylate; pentaerythritol tetraacrylate; dipentaerythritol hexaacrylate; 1,10 decanediol diacrylate; 1,3-butylene glycol diacrylate; 1,4-butanediol diacrylate; 1,9-nonanediol diacrylate; 2-(2-Vinyloxyethoxy) ethyl acrylate; 2-butyl-2-ethyl-1,3-propanediol diacrylate; 2-methyl-1,3-propanediol diacrylate; 2-methyl-1,3-propanediyl ethoxy acrylate; 3 methyl 1,5-pentanediol diacrylate; alkoxylated cyclohexane dimethanol diacrylate; alkoxylated hexanediol diacrylate; cyclohexane dimethanol diacrylate; ethoxylated cyclohexane dimethanol diacrylate; diethyleneglycol diacrylate; dioxane glycol diacrylate; ethoxylated dipentaerythritol hexaacrylate; ethoxylated glycerol triacrylate; ethoxylated neopentyl glycol diacrylate; hydroxypivalyl hydroxypivalate diacrylate; neopentyl glycol diacrylate; poly (tetramethylene glycol) diacrylate; polypropylene glycol 400 diacrylate; polypropylene glycol 700 diacrylate; propoxylated (6) ethoxylated bisphenol A diacrylate; propoxylated ethylene glycol diacrylate; propoxylated (5) pentaerythritol tetraacrylate; and propoxylated trimethylol propane triacrylate or mixtures thereof.

Preferably the (meth)acrylic monomer (M2) is chosen from ethylene glycol dimethacrylate, neopentyl glycol diacrylate, neopentyl glycol dimethacrylate, 1,4-butanediol dimethacrylate, 1,4-butanediol diacrylate, 1,3-butylene glucol diacrylate, 1,3-butylene glycol dimethacrylate, triethylene glycol dimethacrylate and triethylene glycol diacrylate or mixtures thereof.

The (meth)acrylic monomer (M2) can be present in (meth)acrylic composition MCI between 0.01 and 10 phr by weight, preferably is present between 0.1 and 9.5 phr for 100 parts of a liquid (meth)acrylic syrup (or the (meth)acrylic composition MCI) comprising (meth)acrylic monomer (Ml) and a (meth)acrylic polymer (PI), more preferably between 0.1 and 9 phr, even more preferably between 0.1 and 8.5 phr and advantageously between 0.1 and 8 phr.

In a first more preferred embodiment the (meth)acrylic monomer (M2) is present in (meth)acrylic composition MCI between 0.01 and 9 phr and is chosen from a compound comprising two (meth)acrylic functions.

In a second more (meth)acrylic monomer (M2) is present in (meth)acrylic composition MCI between 0.01 and 9 phr and is chosen from a mixture of compounds comprising two (meth)acrylic functions.

In a third more preferred embodiment the (meth)acrylic monomer (M2) is present in (meth)acrylic composition MCI between 0.01 and 9 phr and is chosen from a mixture of compounds comprising at least two (meth)acrylic functions.

In a fourth more preferred embodiment the (meth)acrylic monomer (M2) is present in (meth)acrylic composition MCI between 0.01 and 9 phr and is chosen from a mixture of compounds comprising at least two (meth)acrylic functions. At least one compound of the mixture comprises only two (meth)acrylic functions and presents at least 50 wt % of the mixture of (meth)acrylic monomer (M2), preferably at least 60 wt %. The other compound of the mixture comprises more than two (meth)acrylic functions.

According to another embodiment of the step of wetting, the thermoplastic composition may be a thermoplastic resin precursor.

A precursor or an initiator (Ini) will be able to continue the polymerization or start the polymerization of the (meth) acrylic monomers (Ml) and (M2), and it is chosen from a radical initiator.

Preferably the initiator (Ini) is activated by heat.

The radical initiators (Ini) can be chosen from a peroxy group comprising compound or an azo group comprising compounds and preferably from a peroxy group comprising compound.

Preferably the peroxy group comprising compound comprises from 2 to 30 carbon atoms.

Preferably the peroxy group comprising compound is chosen from diacyl peroxides, peroxy esters, peroxydicarbonates, dialkyl peroxides, peroxyacetals, hydroperoxide or peroxyketale; or mixtures.

The initiator (Ini) is chosen from diisobutyryl peroxide, cumyl peroxyneodecanoate, di (3-methoxybutyl) peroxydicarbonate 1,1,3,3-Tetramethylbutyl peroxyneodecanoate, cumyl peroxyneoheptanoate, di-n-propyl peroxydicarbonate, tert-amyl peroxyneodecanoate, di-sec-butyl peroxydicarbonate, diisopropyl peroxydicarbonate, di (4-tert-butylcyclohexyl) peroxydicarbonate, di-(2-ethylhexyl)-peroxydicarbonate, tert-amyl peroxyneodecanoate, tert-butyl peroxyneodecanoate, di-n-butyl peroxydicarbonate, dicetyl peroxydicarbonate, dimyristyl peroxydicarbonate, 1,1,3,3-tetramethylbutylperoxypivalate, tert-butyl peroxyneoheptanoate, tert-amyl peroxypivalate, tert-butyl peroxypivalate, di-(3,5,5-trimethylhexanoyl 1-peroxide, dilauroyl peroxide, didecanoyl peroxide, 2,5-dimethyl-2,5-di (2-ethylhexanoylperoxy)-hexane, 1,1,3,3-tetramethylbutyl peroxy-2-ethylhexanoate, tert-amyl peroxy-2-ethylhexanoate, dibenzoyl peroxide, tert-butyl peroxy-2-ethylhexanoate, tert-butyl peroxydiethylacetate, tert-butyl peroxyisobutyrate, 1,1-di-(tert-butylperoxy)-3,3,5-trimethylcyclohexane, 1,1-di (tert-amylperoxy) cyclohexane, 1,1-di-(tert-butylperoxy)-cyclohexane, tert-amyl peroxy-2-ethylhexylcarbonate, 1 tert-amyl peroxyacetate, tert-butyl peroxy-3,5,5-trimethylhexanoate, 2,2-di-(tert-butylperoxy)-butane, tert-butyl peroxyisopropylcarbonate, tert-butyl peroxy-2-ethylhexylcarbonate, tert-amyl peroxybenzoate, tert-butyl peroxyacetate, butyl 4,4-di (tert-butylperoxy) valerate, tert-butyl peroxybenzoate, di-tert-amylperoxide, dicumyl peroxide, di-(2-tert-butyl-peroxyisopropyl)-benzene, 2,5-dimethyl-2,5-di-(tert-butylperoxy)-hexane, tert-butylcumyl peroxide, 2,5-dimethyl-2,5-di (tert-butylperoxy) hexyne-3, di-tert-butyl peroxide, 3,6,9-triethyl-3,6,9-trimethyl-1,4,7-triperoxonane, 2,2′-azobis-isobutyronitrile (AIBN), 2,2′-azodi-(2-methylbutyronitrile), azobisisobutyramide, 2,2′-azobis (2,4-dimethylvaleronitrile), 1,1′-Azodi (hexahydrobenzonitrile), or 4,4′-azobis (4-cyanopentanoic); or mixtures thereof.

Preferably the initiator (Ini) is chosen from cumyl peroxyneodecanoate, di (3-methoxybutyl) peroxydicarbonate, 1,1,3,3-tetramethylbutyl peroxyneodecanoate, cumyl peroxyneoheptanoate, di-n-propyl peroxydicarbonate, tert-amyl peroxyneodecanoate, di-sec-butyl peroxydicarbonate, diisopropyl peroxydicarbonate, di (4-tert-butylcyclohexyl) peroxydicarbonate, di-(2-ethylhexyl)-peroxydicarbonate, tert-amyl peroxyneodecanoate, tert-butyl peroxyneodecanoate, di-n-butyl peroxydicarbonate, dicetyl peroxydicarbonate, dimyristyl peroxydicarbonate, 1,1,3,3-tetramethylbutylperoxypivalate, tert-butyl peroxyneoheptanoate, tert-amyl peroxypivalate, tert-butyl peroxypivalate, di-(3,5,5-trimethylhexanoyl)-peroxide, dilauroyl peroxide, didecanoyl peroxide, 2,5-dimethyl-2,5-di (2-ethylhexanoylperoxy)-hexane or 1,1,3,3-tetramethylbutyl peroxy-2-ethylhexanoate; or mixtures thereof.

The thermoplastic composition may comprise between 0.1 phr and 5 phr of an initiator (Ini) to start the polymerization of the (meth)acrylic monomer (Ml) and (meth)acrylic monomer (M2).

The method 100 according to the invention may comprise a step of heating 130. Preferably the step of heating is implemented by a heating device 15. The step of heating allows to trigger and initiate the polymerization 131 of the thermoplastic composition 14 which has impregnated fibers 12 to form a heated thermoplastic composite 16 having a first section S1.

The heating allows also to increase the space between the molecules, which allows to increase the flexibility of the heated thermoplastic composite in order to facilitate the next step of shaping. As explained thermoplastic composite have the specificity of being generally solid at room temperature and while softening during an increase in temperature, in particular after passing its glass transition temperature (Tg) or the melting temperature (Tf) and becoming solid again when the temperature drops below its melting point and below its glass transition temperatures. Thanks to the step of heating, the polymerization takes place which increases the partial fluidity and flexibility; thus the heated thermoplastic composite will be more deformable.

The step of heating may comprise a heating by convection, by conduction, by IR (infrared) (comprising NIR and MIR (near and mid infrared)), by microwave, by UV (ultraviolet) and/or by induction.

According to an embodiment of the step of heating 130, the polymerization may take place at a temperature typically below 140° C., preferably below 130° C. and even more preferably below 125° C.

According to an embodiment of the step of heating, the polymerization may take place at a temperature of at least 40° C., preferably at least 50° C. and more preferably at least 60° C.

Preferably the polymerization may take place at temperature between 40° C. and 140° C., preferably between 50° C. and 130° C., even more preferably between 60° C. and 125° C.

Advantageously, the step of heating may be implemented continuously or not.

The heating step and the polymerization allow to pass from a thermoplastic composition which has impregnated the fibers (thermoplastic resin or a thermoplastic resin precursor) and which is liquid to a heated thermoplastic composite 16.

The heating step allows to obtain a heated thermoplastic composite 16 with a first section S1.

The first section may comprise a predetermined thickness or width, and/or diameter (internal or external), or volume or area or perimeter.

The thermoplastic composite, preferably the heated thermoplastic composite, may have different geometries. The geometry may be tubular, conical, oval, pyramidal, cubic or cuboid. Preferably, the thermoplastic composite is not limited by its geometry. In addition, the thermoplastic composite, preferably the heated thermoplastic composite, may have different dimension such as thickness, diameter, length, width, height, area, volume, perimeter.

Preferably, the heated thermoplastic composite is not limited by its dimension for example by its length.

The first section of the thermoplastic composite and preferably of the d thermoplastic composite may have different geometries according to the geometry of the heated thermoplastic composite. For example, the section may be circular, triangle, square, rectangle, parallelepipedal, trapezoid. Preferably, the section is not limited by its geometry. The first section of the thermoplastic composite and preferably of the heated thermoplastic composite may have different dimension according to the dimension of the heated thermoplastic composite. Preferably, the section is not limited by its dimension.

For example, if the heated thermoplastic composite is conical, the first section may be circular, elliptical, parabolic or hyperbolic. Preferably the section is determined according to a transverse axis. According to another example, the heated thermoplastic composite may be pyramidal, in this context the first section may be triangle, or the heated thermoplastic composite may be tubular, and the first section may be parallelepipedal, rectangular, square, trapezoid. The geometry may influence the polymerization. Thus, depending on the geometry of the thermoplastic composite, more monomer can be converted into polymer and improving the impregnation.

During the heating step, the resin has usually a high volume shrinkage between 5% and 20% (18% on the pure resin) when it polymerizes from liquid resin to solid. This shrinkage leads to a loss of pressure in the pultrusion process. This loss of pressure causes relatively high porosity leading to decreased mechanical properties, more residual monomer, higher water uptake, change of electrical conductivity and chemical resistance of thermoplastic composite.

The method according to the invention may comprise a step of shaping 140 the heated thermoplastic composite 16. Preferably, the step is implemented by pulling the heated thermoplastic composite 16 through a shaping device 17. The shaping device 17 has a second section S2, and the second section S2 being smaller than the first section S1. The step of shaping 140 allows to provide a heated thermoplastic composite 18 having a second section S2.

Advantageously, during the step of shaping 140, the heated thermoplastic composite 16 pass through the shaping device 17 wherein, thanks to the smaller section of the shaping device 17, a pressure is applied to the heated thermoplastic composite 16. Preferably, the heated thermoplastic composite 16 is further heated and therefore deformable. Heating the heated thermoplastic composite 16 allows to facilitate the step of shaping 140.

Preferably the temperature of the heated thermoplastic composite at the shaping device inlet may be between 100° C. and 160° C., and preferably above the Tg.

Advantageously, the duration of the shaping step may be predetermined according to the thermoplastic composition, the rate of fiber content and/or the first section of the heated thermoplastic composite. For example, the duration of the shaping step may be between 10 seconds and 3 minutes, depending on the pulling rate and the length of the shaping device.

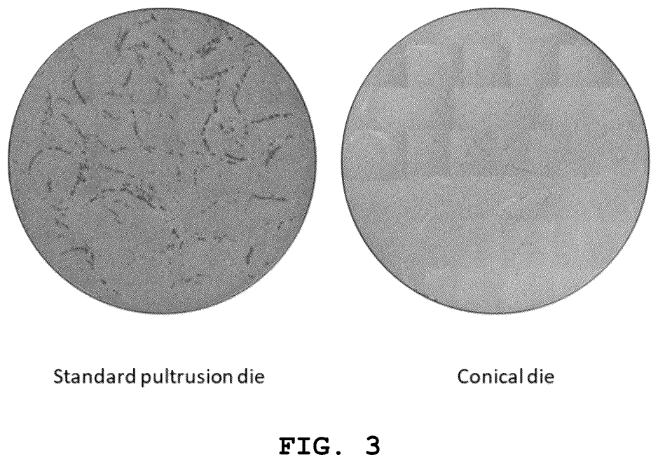

As explained, the shaping step comprises the application of pressure (resulting from the smaller section of the shaping device) which, surprisingly results in a reduction of the porosity. Indeed, as illustrated in FIG. 3, the porosity content has decreased from 5% to 18, as measured by microscopic analysis (optic) and porosity measurement by calcination test (ISO1172). In addition, due to the reduced porosity, less “air” and volatile compounds are present in the thermoplastic composite and therefore less empty space within the thermoplastic composite is present, which leads to less water absorption and therefore a lower electrical conductivity and a better chemical resistance. Indeed, with less porosity and less empty space, less water can penetrate into the thermoplastic composite and therefore with less water penetration, less water uptake (by weighing). In addition, thanks to the step of heating before the step of shaping, less volatile compounds are trapped in fibers which also allows to decrease porosity. Moreover, if the thermoplastic composite is less porous, the better its conductivity will be. In addition, the aspect of the surface is better such as glossier and more smoothly. A better aspect of surface is important for optional step of coating or varnishing or wrapping. In addition, the shaping step allows to counterbalance the effect of shrinkage.

According to an embodiment, the shaping step may reduce from 1 to 15% in volume the heated thermoplastic composite. Preferably, the shaping step may reduce from 2% to 12% in volume and more preferably from m % to 10% in volume the heated thermoplastic composite.

According to another embodiment, the shaping step may reduce from 1% to 15% in diameter the heated thermoplastic composite. Preferably, the shaping step may reduce from 2% to 12% in diameter and more preferably from 3% to 10% in diameter the heated thermoplastic composite.

According to another embodiment, the shaping step may reduce from 18 to 15% in surface or area the heated thermoplastic composite. Preferably, the shaping step may reduce from 2% to 12% in surface or area and more preferably from 3% to 10% in surface or area the heated thermoplastic composite.

According to another embodiment, the shaping step may reduce from 1% to 15% the perimeter of the heated thermoplastic composite. Preferably, the shaping step may reduce from 2% to 12% the perimeter and more preferably from 3% to 10% the perimeter of the heated thermoplastic composite.

For example, the shaping device may be configured so that a heated thermoplastic may have a first section such as a diameter about 13 mm and a second section about 12.6 mm.

According to another example, the shaping device may be configured so that the heated thermoplastic composite may have a first section such as a thickness about 10 mm and a second section about 9.7 mm in one dimension while the thickness (width) in the perpendicular dimension stays the same for both sections or is reduced as well.

The invention is not limited by precise values but applies very advantageously to any type of section values.

The second section of the heated thermoplastic composite having a second section may have a same geometry to the first section of the heated thermoplastic composite having a first section.

For example, the first section of the heated thermoplastic composite may be circular, and the second section of the same heated thermoplastic composite having the second section may also be circular after the passage through the shaping device but with a different dimension such as the second section is smaller than the first section for example in diameter and/or area and/or perimeter.

Alternatively, the second the section of heated thermoplastic composite with a second section may have a different geometry to the first section of the heated thermoplastic composite with a first section after the passage through the shaping device.

For example, the first section of the heated thermoplastic composite may be circular or tubular, and the second section of the same heated thermoplastic composite with the second section may be square after the passage through the shaping device with a different dimension such as the second section is smaller than the first section for example area and/or perimeter.

According to another example, a first section of the heated thermoplastic composite may be parallelepipedal and the second section of the same heated thermoplastic composite with the second section may be rectangular, square or even trapezoid after the passage through the shaping device, with a different dimension such as the second section is smaller than the first section for example area and/or perimeter.

The second section is smaller than the first section in at least one dimension.

In order to improve even more the porosity and the properties of the heated thermoplastic composite, the method according to the invention may comprise a step of evacuation 135. Preferably, the step of evacuation comprises air evacuation, volatile compounds evacuation, monomer evacuation, reagent evacuation, other fluid, and/or gaseous compounds. Advantageously, the evacuation step may take place before the step of shaping. A step of evacuation may be implemented by an air space (referred as AIR in FIG. 2), by a vacuum or by an empty space between the pultrusion die and the shaping device. The evacuation may be implemented by applying a vacuum between the pultrusion die and the shaping device. The evacuation step allows a degassing before the step of shaping.

The method according to the invention may comprise a step of cooling 150. In a particular embodiment, the step of cooling may be implemented by a cooling device 19. In addition, the step of cooling may be implemented at a given cooling temperature and/or for a given cooling duration.

According to an embodiment, the cooling temperature and/or the cooling duration may be selected in accordance with the glass transition temperatures (Tg) and/or the melting temperature of the heated thermoplastic composite. Preferably, the step of cooling is at a cooling temperature below to a glass transition temperature of the heated thermoplastic composite having the second section. For example, the Tg may be below 130° C., preferably below 120° C. and more preferably below 110° C. The glass transitions (Tg) of the polymers may be measured with equipment able to realize a thermo mechanical analysis (DMA). A RDAII “Rheometrics Dynamic Analyser” proposed by the Rheometrics Company has been used. The thermo mechanical analysis measures precisely the visco-elastics changes of a sample in function of the temperature, the strain or the deformation applied. The apparatus records continuously, the sample deformation, keeping the stain fixed, during a controlled program of temperature variation. The results are obtained by drawing, in function of the temperature, the elastic modulus (G′), the loss modulus (G″) and the tan delta. The Tg is highest temperature value read in the tan delta curve, when the derivative of tan delta is equal to zero.

According to another embodiment, the cooling temperature and/or the cooling duration may be selected in accordance with the dimensions of the heated thermoplastic composite, according to the heating temperature, according to the heating duration, according to the type of heating, according to the section of the thermoplastic composite, according to the geometry of the thermoplastic composite, according to the pulling rate, according to the length of the cooling device and/or according to the thermoplastic composition.

For example, the cooling temperature may be less than or equal to 150° C., preferably less than or equal to 130° C. more preferably less than or equal to 110° C. and even more preferably less than or equal to 100° C. The cooling temperature may be more than or equal to 50° C., preferably more than or equal to 60° C., more preferably more than or equal to 70° C. even more preferably more than or equal to 80° C. The cooling temperature may be between 50° C. and 150° C., preferably between 60° C. and 130° C., more preferably between 70° C. and 130° C., even more preferably between 80° C. and 110° C.

The step of cooling 150 allows to produce a shaped thermoplastic composite 10, preferably, to produce a shaped thermoplastic composite having the second section. More preferably, the step of cooling allows to stabilize the geometry and in particular the section.

According to a preferred embodiment, the step of cooling may be at the same time as the step of shaping. According to another embodiment, the step of cooling may be after the step of shaping.

The method according to the invention may comprise other optional steps 160 such as coating, bending, heating, cooling, cutting, welding, gluing and/or laminating. The optional step may be implemented according to the shaped thermoplastic composite to produce. The optional step may also improve the qualities and/or properties of the shaped thermoplastic composite.

According to another embodiment, the invention concerns a shaped thermoplastic composite 10 obtainable, preferably obtained, from the method according to the invention.

As explained a shaped thermoplastic composite according to the invention comprises a polymeric matrix and fibers.

According to an embodiment, the shaped thermoplastic composite may comprise at least 50 in volume of fibers, preferably at least 60% in volume of fibers and more preferably at least 70% in volume of fibers.

A shaped thermoplastic composite is preferably obtained from a thermoplastic composite comprising 35% or less in volume of a polymeric matrix including (meth)acrylic polymers, and at least 65% in volume of fibers. It may be also obtained from a thermoplastic composite comprising from 20% to 30% in volume of a polymeric matrix including (meth)acrylic polymers, and from 70% to 80% in volume of fibers.

According to an embodiment, the shaped thermoplastic composite may comprise from 20 to 30% in volume of a polymeric matrix and 60 to 80% in volume of fibers.

Preferably, the polymeric matrix may include at least 20% in weight of (meth)acrylic polymers, and at least 60% in volume of fibers.

In addition, said (meth)acrylic polymers may be crosslinked.

A shaped thermoplastic composite can have different sections such as circular, elliptical, parabolic or hyperbolic triangle, oval, parallelepipedal. Preferably, the section can be defined by an axis perpendicular to the longitudinal axis of the shaped thermoplastic composite. The shaped thermoplastic composite is not limited by the geometry of the section.

A shaped thermoplastic composite may have different dimension (thickness, diameter, length, width, height).

A shaped thermoplastic composite is preferably used to produce a reinforcing element to reinforcing a structure. A reinforcing element may be for example a panel, a rod, a bar, a rebar, or a sheet. According to an embodiment, the shaped thermoplastic composite may comprise several sheets.

Advantageously, the shaped thermoplastic composite according to the invention meets all the requirements of the standard Specification for Solid Round Glass Fiber Reinforced Polymer Bars for Concrete Reinforcement.

Advantageously, a shaped thermoplastic composite according to the invention may have a porosity less than or equal to 10%, preferably less than or equal to 8%, more preferably less than or equal to 5% and even more preferably less than or equal to 1%. The porosity may be measured by optical microscopy analysis and/or by a calcination test. Thanks to its low porosity, the shaped thermoplastic composite according to the invention has better mechanical properties and thermal qualities, better chemical properties and chemical resistance, better electric conductivity properties and less water uptake.

For example, the shaped thermoplastic composite according to the invention may comprise a water uptake between 5 and 15% wt of the said shaped thermoplastic composite whereas the same thermoplastic composite without shaping according to the invention comprises a water uptake between 20 and 40%. The water uptake may be measured by weighing (adapted to the ASTM D570). The shaped thermoplastic composite according to the invention has a water uptake divided by 2 in comparison to the same thermoplastic composite without shaping according to the invention. The shaped thermoplastic composite according the to invention has an improvement between 10% and 50%.

Advantageously, a shaped thermoplastic composite according to the invention may comprise a roughness less than the same thermoplastic composite without shaping. For example, the shaped thermoplastic composite according to the invention may be smoother or glossier at its outer surface. The aspect of the surface may be important in case where a treatment is applied to the surface of the thermoplastic composite, for example with coating. Indeed, the treatment will be easier with the shaped thermoplastics composites of the invention, for example more penetrating and of a longer lasting. The aspect may be measured, by any method currently used in the art, eg. by visual measurement.

According to another aspect of the invention, the invention concerns a use of a shaped thermoplastic composite according to the invention in automotive, transport, nautical, railroad, sport, aeronautic, aerospace, photovoltaic, computing, construction and building, telecommunication and/or wind energy applications.

According to another aspect, the invention concerns a shaping device 17. The shaping device is configured to reduce a first section of a thermoplastic composite, preferably a thermoplastic composite according to the invention and even more preferably a heated thermoplastic composite according to the invention, to a second section to form a shaped thermoplastic composite, preferably according to the invention, with a second section, said second section being smaller than the first section. The second section is smaller than the first section in at least one dimension such as diameter and/or perimeter and/or area. In this context, the shaped thermoplastic composite has at least one dimension smaller than the heated thermoplastic composite, the dimension may be volume, perimeter and/or diameter for example.

Advantageously, a shaping device according to the invention comprises at least one inlet and at least one outlet. At least one inlet is preferably facing the pultrusion die. At least one outlet is preferably facing the cooling die. In addition, the outlet is smaller than the inlet, in at least one dimension, preferably the section of the outlet is smaller than the section of the inlet.

According to an embodiment of the invention, the shaping device may comprise a heating device and/or a cooling device. Indeed, according to the section of the thermoplastic composite or according to the final form of the shaped thermoplastic composite, the shaping device may be configured to heat and/or cool the shaped thermoplastic composite to bend or to manipulate the shaped thermoplastic composite.

The shaping device may comprise a mold, a forming channel and/or a heat-adjustable mold.

A shaping device according to the invention is not limited to a particular form or a particular geometry or dimension. A shaping device may have an adaptable form or geometry or dimension depending on the reduction in section of the thermoplastic composite.

For example, a shaping device may be conical, pyramidal, or a wedge frustum.

Moreover, a shaping device according to the invention is not limited in size. For example, a shaping device may have a different length, thickness, diameter, width, slope. Preferably, this makes it possible to adapt the shaping device to the first-section thermoplastic to obtain a second-section composite thermoplastic composite.

Advantageously, the sections of the shaping device may also be adjustable, and/or adaptable.

According to a preferred embodiment, the shaping device according to the invention may be configured to be adaptable to a dimension of the thermoplastic composite. Preferably, the shaping device according to the invention may be configured to be adaptable to the heated thermoplastic composite. More preferably, the shaping device according to the invention may be configured to be adaptable to the shrinkage of the resin in the heated thermoplastic composite. The shrinkage may be between 3% and 15%.

Advantageously, the inlet of the shaping device corresponds perfectly in dimension to the last device of the pultrusion die. For example, if the last pultrusion device in the pultrusion die is a heating device, then the inlet to the shaping device has the same dimensional characteristics as the heating device.

Preferably, the shaping device is removable. The shaping device may be fixed in a non-definitive manner to the pultrusion die and preferably to the mold preceding the inlet of the shaping device, so that the heated thermoplastic composite having a first section enters the inlet shaping device. The removable fixation corresponds to the ability to be easily detached, removed or dismantled without having to destroy the fastening means either because there is no fastening means or because the fastening means are easily and quickly removable (eg notch, screw, tab, lug, clips). For example, by removable, it should be understood that the object is not fixed by welding or by any other means not intended to allow the object to be detached. This also makes it possible to vary the sections and to be adaptable to any type of section of the thermoplastic composite.

For example, the shaping device may be mechanically fixed, by screwing to the preceding mold of the inlet of the shaping device in the pultrusion die.

Alternatively, the shaping device may be irremovably fixed to the pultrusion die, for example by welding the inlet of the shaping device to the preceding mold of the pultrusion die.

According to another alternative, the shaping device may be placed at a distance from the pultrusion die in order to leave a gap between the pultrusion die and the shrinkage die (i.e. the shaping device). The gap may be configured to create an empty space authorizing a degassing before the shaping device and/or a vacuum and/or an air space.

The shaping device allows to reduce the section of the thermoplastic composite and more preferably to the heated thermoplastic composite.

The shaping device may correspond to a constriction area.

The shaping device makes it possible in a particularly advantageous way, thanks to its section adapted to each type of thermoplastic composite, to apply pressure on the thermoplastic composite in order to reduce the porosity of the thermoplastic composite.

Advantageously the shaping device may be digitally 1 automatically controlled and/or moved or manually controlled.

According to another aspect, the invention concerns a system 200 for producing a shaped thermoplastic composite. An example of a system is illustrated in FIG. 2.

A system 200 for producing a shaped thermoplastic composite 10 may comprise:
a fiber feeder device 11, configured to provide fibers 12 in a direction of pultrusion path A,
an impregnation device 13, configured to wet fibers 12 through a thermoplastic composition 14, said thermoplastic composition 14 being a thermoplastic resin or a thermoplastic resin precursor and comprising at least 50% in weight of monomers,
a heating device 15 configured to cause a polymerization of the thermoplastic composition 14 to form a heated thermoplastic composite 16 with a first section S1,
a shaping device 17 configured to shape the heated thermoplastic composite 16 according to a second section S2, the shaping device 17 having a second section, and the second section being smaller than the first section, to provide a heated thermoplastic composite 18 with a second section, the shaping device 17 being adjusted to the previous device preferably the shaping device being facing device,
a cooling device 19, configured at a cooling temperature below to a glass transition temperature of the heated thermoplastic composite with the second section 18 to produce a shaped thermoplastic composite 10.

Preferably all the devices of the system operate continuously.

A system 200 according to the invention may comprise a fiber feeder device 11. A fiber feeder device is configured to provide fibers 12 in a direction of a pultrusion path A.

A fiber feeder device may include at least one spool, reel, wheel around which fibers are wound. These fibers may be unwound from said spool, reel, wheel by one or more redirecting and guiding means which guide and connect the unwound fibers to assemble the fibers into a bundle.

This bundle with fibers is pulled, by traction, towards an impregnation device 13.

The system 200 according to the invention may comprise a pulling device which pulls fibers, in the advancement direction and preferably in the pultrusion path A. For example, a pulling device may comprise one or more preferably opposite jaws or gripping surfaces, and actuated so as to drive in direction A the fibers, the thermoplastic composite, the heated thermoplastic composite. The speed of the device may be configurable.

The system 200 may comprise an impregnation device 13 configured to wet fibers 12 through a thermoplastic composition 14, said thermoplastic composition 14 being a thermoplastic resin or a thermoplastic resin precursor and comprising at least 50% in weight of monomers. Preferably, the thermoplastic composition is the thermoplastic composition disclosed above.

For example, the pulling device may be configured to guide fibers through one or several bath, one or several injection chamber one or several soaking tanks, one or more impregnation chambers.

The impregnation device is configured to receive the fibers and to wet fibers by capillary absorption or injection so as to ensure complete impregnation of the fibers with the thermoplastic composition, preferably in liquid form.

According to one embodiment, the impregnation device may comprise a comb, a wiper, a succession of rings of decreasing diameter, a tubular channel, so as to eliminate the excess of thermoplastic composition.

The system according to the invention may comprise a heating device 15 configured to cause a polymerization of the thermoplastic composition 14 to form a heated thermoplastic composite 16 with a first section 1.

The heating device may be selected from conduction, convection, radial and/or volumetric heating devices.

The heating device may comprise a mold, an enclosure, a microwave source, an IR source (NIR/MIR), an air blower, an oven and/or an induction source. Preferably, the heating device comprises an infrared heating device or a microwave heating device. This ensures a sufficiently uniform heating and to ensure the polymerization of the thermoplastic composition.

The polymerization makes it possible to obtain a thermoplastic composite having a first section, preferably a solid heated thermoplastic composite with a first section.

Advantageously, the heating device may comprise one or more IR or thermometer type heating sensors in order to control the different heating temperatures and/or a timer, to control the heating duration.

The system according to the invention may comprise a shaping device 17. Preferably a shaping device such as disclosed above.

A shaping device 17 is configured to shape the heated thermoplastic composite 16 according to a second section S2. The shaping device 17 may have an inlet and an outlet and preferably the inlet has a first section and the outlet has a second section and more preferably the second section, is smaller than the first section, to provide a heated thermoplastic composite 18 with a second section. The shaping device is configured to apply a pressure on the heated thermoplastic composite with a first section reduce the first section to a second section. Preferably the pressure is applied through the section of the shaping device, and preferably the second section, which is smaller than the heated thermoplastic composite with a first section.

Advantageously, the shaping device 17 is adjusted to the previous device, or the previous mold of the pultrusion die. Preferably, the pultrusion die comprises all the devices before the shaping device. The shaping device may be perfectly adapted, fitted to the dimensional features of the preceding mold or device. Preferably, the inlet of the shaping device is adapted to the dimensional feature of the preceding mold or device. Preferably, the outlet of the shaping device facing the cooling device.

According to an embodiment, the shaping device is at a distance from the previous mold or device so as to allow degassing and/or applying a vacuum. In this context, the system may comprise an air space, a vacuum or an empty space. Preferably the air space, the vacuum, or the empty space is arranged between the heating device and the shaping device.

The system according to the invention may comprise a cooling device 19. A cooling device may be configured at a cooling temperature below to the glass transition temperature of the heated thermoplastic composite with the second section 18 to produce a shaped thermoplastic composite 10.

A cooling device of the system of the invention can be configured to solidify the heated thermoplastic composite with the second section to form a shaped thermoplastic composite.

Preferably, the cooling device allows to sufficiently cooling thermoplastic composite so that the said heated the heated thermoplastic composite becomes solid and can be removed from the system without deformation.

Advantageously, said cooling device may be configured to cool the heated thermoplastic composite directly or indirectly, i.e. by direct contact or not.

A cooling device may allow cooling the heated thermoplastic composite to temperature a cooling allowing the heated thermoplastic composite transitions to a solid state and a thermal shrinkage. A thermal shrinkage can be between 0 and 5%, preferably between 1% and 5%.

Preferably the cooling temperature is below to the glass transition temperature of the thermoplastic composite, and preferably below to the glass transition temperature of the heated thermoplastic composite. For example, less than or equal to 120° C., preferably less than or equal to 110° C.

In addition, a cooling device is adapted to achieve rapid cooling of the heated thermoplastic composite. It may depend on the length and pulling speed. Advantageously, only the shape of the shaped heated thermoplastic composite is cooled.

Advantageously, it may be instantaneous or alternatively a slow cooling.

For this purpose, the shaping device may be equipped with a cooling device to actively cool the heated thermoplastic composite. This may include compressed air.

Alternatively, the cooling device may be adapted to induce a passive cooling or automatic cooling. It may be a mold, a nozzle, a refrigerant circuit, a flow of a cooling fluid and/or fan.

Preferably the system comprises a specific arrangement of the different devices. For example, it is preferable that the feeding device appears before the impregnating device in the direction A of the pultrusion path. It is also preferable that the impregnating device appears before the heating device, which appears before the shaping device, which appears before the cooling device.

Advantageously, a vacuum or an empty space or an air space is arranged between the heating device and the shaping device. This arrangement is particularly advantageous for reducing the porosity of the shaped thermoplastic composite, the volatile compounds, and for improving the mechanical and chemical properties.

The system according to the invention may comprise other devices such as a bending device, twisting device, a cutting device, a vacuum device, a surface texturing device.

The invention can be the subject of numerous variants and applications other than those described above. In particular, unless otherwise indicated, the structural and different functional characteristics of each of the implementations described above should not be considered as combined and/or closely and/or inextricably linked to each other, but on the contrary as simple juxtapositions. In addition, the structural and/or functional characteristics of the various embodiments described above may be the subject in whole or in part of any different juxtaposition or any different combination.

### Example

Table 1: Example for a rod thermoplastic composite obtained through the shaping method of the invention and without shaping and comprising 60% of fibers and at least 20% of thermoplastic composition with an (meth)acrylic resin.

A liquid composition is prepared by dissolving 25% by weight of the PMMA (BS520, a copolymer of MMA comprising ethyl acrylate as comonomer) as (P1) in 75% by weight of methyl methacrylate as (M1), which is stabilized with HOME (hydroquinone monomethyl ether) as (meth)acrylic composition MCI. 2 phr dilauroyl peroxide (LP—Luperox® LP from the company Arkema) are added to the liquid composition.

This liquid composition is used in a pultrusion process in a method and device according to the invention comprising the shaping step and shaping device and a comparative method and device not comprising said shaping step and shaping device.

The heating device during heating stop is at 120° C.

The obtained respective rods are evaluated by measuring especially the respective diameters, porosity and water uptake. The results are summarized in table 1.

TABLE 1

| | | |
|---|---|---|
| Parameter | Shaping | No shaping |

| | | | | |
|---|---|---|---|---|
| External diameter - | 13 | mm | 13 | mm |

Section 1

| | | | | |
|---|---|---|---|---|
| External diameter - | 12.6 | mm | 12.97 | mm |

| | | |
|---|---|---|
| Section 2 | | |
| Form | rod | rod |
| Porosity | 1% | 5% |
| Water uptake at 50° C. | 0.15% | 0.36% |
| after 168 h | | |

| | | | | |
|---|---|---|---|---|
| Strength | 1100 | MPa | 1000 | MPa |

As shown in table 1, the shaped thermoplastic composite according to the invention shows improved chemical and mechanical properties, and in particular a low porosity.

1. A method for producing a shaped thermoplastic composite, said method comprising a pultrusion process and comprising:
a step of feeding, by a fiber feeder device, said step of feeding provides fibers in a direction A of a pultrusion path,
a step of wetting fibers, by an impregnation device, which comprises the passage of fibers through a thermoplastic composition, said thermoplastic composition being a thermoplastic resin or a thermoplastic resin precursor and comprising at least 50% in weight of monomers,
a step of heating, by a heating device, which includes a polymerization of the thermoplastic composition having impregnated the fibers to form a heated thermoplastic composite having a first section,
a step of shaping the heated thermoplastic composite, by pulling the heated thermoplastic composite through a shaping device, the shaping device having a second section, and the second section being smaller than the first section, to provide a heated thermoplastic composite having a second section, and
a step of cooling, by a cooling device, at a cooling temperature below to a glass transition temperature of the heated thermoplastic composite having the second section to produce a shaped thermoplastic composite.

2. The method for producing the shaped thermoplastic composite according to the claim 1, wherein the pultrusion process is a reactive pultrusion process.

3. The method for producing the shaped thermoplastic composite according to claim 1, wherein the feeding step and the wetting step are carried out so that the shaped thermoplastic composite comprises at least 60% in volume of fibers.

4. The method for producing the shaped thermoplastic composite according to claim 1, wherein the step of cooling is at the same time as the step of shaping.

5. The method for producing the shaped thermoplastic composite according to claim 1, wherein the method comprises a step of evacuation before the step of shaping.

6. The method for producing the shaped thermoplastic composite according to claim 1, wherein the thermoplastic composition is a (meth)acrylic composition MCI comprising a (meth)acrylic monomer (MI) and a (meth)acrylic polymer (PI).

7. The method for producing the shaped thermoplastic composite according to claim 1, wherein the thermoplastic composition comprises between 10 wt % and 50 wt % of a (meth)acrylic polymer (PI) and between 50 wt % and 90 wt % of a (meth)acrylic monomer (MI).

8. The method for producing the shaped thermoplastic composite according to claim 1, wherein the thermoplastic composition or (meth)acrylic composition MCI comprises a (meth)acrylic monomer (M2).

9. The method for producing the shaped thermoplastic composite according to claim 8, wherein the (meth)acrylic monomer (M2) is chosen from a compound comprising at least two (meth)acrylic functions.

10. The method for producing the shaped thermoplastic composite according to claim 8, wherein the (meth)acrylic monomer (M2) is chosen from 1,3-butylene glycol dimethacrylate; 1,4-butanediol dimethacrylate; 1,6 hexanediol diacrylate; 1,6 hexanediol dimethacrylate; diethylene glycol dimethacrylate; dipropylene glycol diacrylate; ethoxylated (10) bisphenol a diacrylate; ethoxylated (2) bisphenol a dimethacrylate; ethoxylated (3) bisphenol a diacrylate; ethoxylated (3) bisphenol a dimethacrylate; ethoxylated (4) bisphenol a diacrylate; ethoxylated (4) bisphenol a dimethacrylate; ethoxylated bisphenol a dimethacrylate; ethoxylated (10) bisphenol dimethacrylate; ethylene glycol dimethacrylate; polyethylene glycol (200) diacrylate; polyethylene glycol (400) diacrylate; polyethylene glycol (400) dimethacrylate; polyethylene glycol (400) dimethacrylate; polyethylene glycol (600) diacrylate; polyethylene glycol (600) dimethacrylate; polyethylene glycol 400 diacrylate; propoxylated (2) neopentyl glycol diacrylate; tetraethylene glycol diacrylate; tetraethylene glycol dimethacrylate; tricyclodecane dimethanol diacrylate; tricyclodecanedimethanol dimethacrylate; triethylene glycol diacrylate; triethylene glycol dimethacrylate; tripropylene glycol diacrylate; ethoxylated (15) trimethylolpropane triacrylate; ethoxylated (3) trimethylolpropane triacrylate; ethoxylated (6) trimethylolpropane triacrylate; ethoxylated (9) trimethylolpropane triacrylate; ethoxylated 5 pentaerythritol triacrylate; ethoxylated (20) trimethylolpropane triacrylate; propoxylated (3) glyceryl triacrylate; trimethylolpropane triacrylate; propoxylated (5.5) glyceryl triacrylate; pentaerythritol triacrylate; propoxylated (3) glyceryl triacrylate; propoxylated (3) trimethylolpropane triacrylate; trimethylolpropane triacrylate; trimethylolpropane trimethacrylate; tris (2-hydroxy ethyl) isocyanurate triacrylate; di-trimethylolpropane tetraacrylate; dipentaerythritol pentaacrylate; ethoxylated (4) pentaerythritol tetraacrylate; pentaerythritol tetraacrylate; dipentaerythritol hexaacrylate; 1,10 decanediol diacrylate; 1,3-butylene glycol diacrylate; 1,4-butanediol diacrylate; 1,9-nonanediol diacrylate; 2-(2-Vinyloxyethoxy) ethyl acrylate; 2-butyl-2-ethyl-1,3-propanediol diacrylate; 2-methyl-1,3-propanediol diacrylate; 2-methyl-1,3-propanediyl ethoxy acrylate; 3 methyl 1,5-pentanediol diacrylate; alkoxylated cyclohexane dimethanol diacrylate; alkoxylated hexanediol diacrylate; cyclohexane dimethanol diacrylate; ethoxylated cyclohexane dimethanol diacrylate; diethyleneglycol diacrylate; dioxane glycol diacrylate; ethoxylated dipentaerythritol hexaacrylate; ethoxylated glycerol triacrylate; ethoxylated neopentyl glycol diacrylate; hydroxypivalyl hydroxypivalate diacrylate; neopentyl glycol diacrylate; poly (tetramethylene glycol) diacrylate; polypropylene glycol 400 diacrylate; polypropylene glycol 700 diacrylate; propoxylated (6) ethoxylated bisphenol A diacrylate; propoxylated ethylene glycol diacrylate; propoxylated (5) pentaerythritol tetraacrylate; and propoxylated trimethylol propane triacrylate; er and mixtures thereof.

11. The method for producing the shaped thermoplastic composite according to claim 8, wherein the (meth)acrylic monomer (M2) in the thermoplastic composition or (meth)acrylic composition MCI is present between 0.01 and 10 phr by weight.

12. A shaped thermoplastic composite obtained from the method according to claim 1.

13. The shaped thermoplastic composite according to claim 1, wherein the shaped thermoplastic composite comprises less than or equal to 10% porosity based on the total volume of the shaped thermoplastic composite.

14. Use of the shaped thermoplastic composite according to claim 1 in automotive, transport, nautical, railroad, sport, aeronautic, aerospace, photovoltaic, computing, construction and building, telecommunication and/or wind energy applications.

15. A shaping device configured to reduce a first section of a heated thermoplastic composite to a second section to form a shaped thermoplastic composite having a second section, said second section being smaller than the first section and the shaped thermoplastic composite comprising at least 60% in volume of fibers.

16. A The shaping device according to the claim 15, wherein the shaping device comprise at least one inlet and at least one outlet, the outlet being smaller than the inlet.

17. A system (200) for producing a shaped thermoplastic composite, comprising
a fiber feeder device, configured to provide fibers in a direction of a pultrusion path A,
an impregnation device, configured to wet fibers through a thermoplastic composition, said thermoplastic composition being a thermoplastic resin or a thermoplastic resin precursor and comprising at least 50% in weight of monomers,
a heating device, configured to cause a polymerization of the thermoplastic composition having impregnated the fibers to form a heated thermoplastic composite having a first section,
a shaping device, configured to shape the heated thermoplastic composite according to a second section, the shaping device having a second section, and the second section being smaller than the first section, to provide a heated thermoplastic composite having a second section, the shaping device being facing to the previous device,
a cooling device configured at a cooling temperature below to a glass transition temperature of the heated thermoplastic composite having the second section to produce a shaped thermoplastic composite.

18. The system for producing the shaped thermoplastic composite according to the claim 17, wherein the system it comprises an empty space, a vacuum, or an air space.

19. The system for producing the shaped thermoplastic composite according to the claim 18, characterized in that the empty space, the vacuum, or the air space is arranged between, the heating device and the shaping device.

20. The system for producing the shaped thermoplastic composite according to claim 17, wherein the shaping device comprises at least one inlet and at least one outlet, the outlet facing the cooling device.

21. The system for producing the shaped thermoplastic composite according claim 17, wherein the shaping device is configured to reduce a first section of a heated thermoplastic composite to a second section to form a shaped thermoplastic composite having a second section, said second section being smaller than the first section and the shaped thermoplastic composite comprising at least 60% in volume of fibers.

22. The system for producing a shaped thermoplastic composite according claim 17, wherein the shaping device comprises at least one inlet and at least one outlet, the outlet being smaller than the inlet.
